(19) United States
(12) Patent Application Publication
(10) Pub. No.: US 2022/0379661 A1
(43) Pub. Date: Dec. 1, 2022

(54) NON-PNEUMATIC TIRE AND RIM ASSEMBLY

(71) Applicant: The Goodyear Tire & Rubber Company, Akron, OH (US)

(72) Inventors: Wesley Glenn Sigler, Barberton, OH (US); Michael Joseph Rachita, Canton, OH (US)

(21) Appl. No.: 17/656,437

(22) Filed: Mar. 25, 2022

Related U.S. Application Data
(60) Provisional application No. 63/193,909, filed on May 27, 2021.

(51) Int. Cl. B60C 7/14; B33Y 80/00

(52) U.S. Cl. CPC B60C 7/146; B33Y 80/00

(57) ABSTRACT

A non-pneumatic tire and wheel assembly which includes a rim, and a spoke ring structure having an inner ring that is mounted on an outer surface of the rim. The inner ring has one or more retention nubs aligned for reception in complementary shaped grooves on the outer surface of the rim, wherein the spoke ring structure has a plurality of spoke members, and an outer tread ring is mounted on the outer circumference of the spoke ring.

### FIELD OF THE INVENTION

The invention relates in general to a vehicle wheel, and more particularly to a non-pneumatic tire and rim assembly.

### BACKGROUND OF THE INVENTION

The pneumatic tire has been the solution of choice for vehicular mobility for over a century. The pneumatic tire is a tensile structure. The pneumatic tire has at least four characteristics that make the pneumatic tire so dominate today. Pneumatic tires are efficient at carrying loads, because all of the tire structure is involved in carrying the load. Pneumatic tires are also desirable because they have low contact pressure, resulting in lower wear on roads due to the distribution of the load of the vehicle. Pneumatic tires also have low stiffness, which ensures a comfortable ride in a vehicle. The primary drawback to a pneumatic tire is that it requires compressed fluid. A conventional pneumatic tire is rendered useless after a complete loss of inflation pressure.

A tire designed to operate without inflation pressure may eliminate many of the problems and compromises associated with a pneumatic tire. Neither pressure maintenance nor pressure monitoring is required. Structurally supported tires such as solid tires or other elastomeric structures to date have not provided the levels of performance required from a conventional pneumatic tire. A structurally supported tire solution that delivers pneumatic tire-like performance would be a desirous improvement.

Non-pneumatic tires are typically defined by their load carrying efficiency. “Bottom loaders” are essentially rigid structures that carry a majority of the load in the portion of the structure below the hub. “Top loaders” are designed so that all of the structure is involved in carrying the load. Top loaders thus have a higher load carrying efficiency than bottom loaders, allowing a design that has less mass.

Thus, an improved non-pneumatic tire is desired that has all the features of the pneumatic tires without the drawback of the need for air inflation is desired. It is also desired to have an improved non-pneumatic tire that has longer tread life as compared to a pneumatic tire of the same size.

### SUMMARY OF THE INVENTION

The invention provides in a first aspect a non-pneumatic tire and wheel assembly comprising: a rim, a spoke ring structure having an inner ring that is mounted on an outer surface of the rim, wherein the inner ring has one or more retention nubs aligned for reception in complementary shaped grooves on the outer surface of the rim, wherein the spoke ring structure has a plurality of spoke members, and an outer tread ring mounted on the outer circumference of the spoke ring.

### Definitions

“Aspect Ratio” means the ratio of a tire's section height to its section width.

“Axial” and “axially” means the lines or directions that are parallel to the axis of rotation of the tire.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Breakers” or “Tire Breakers” means the same as belt or belt structure or reinforcement belts.

“Circumferential” means lines or directions extending along the perimeter of the surface of the annular tread perpendicular to the axial direction; it can also refer to the direction of the sets of adjacent circular curves whose radii define the axial curvature of the tread as viewed in cross section.

“Radial” and “radially” mean directions radially toward or away from the axis of rotation of the tire.

### BRIEF DESCRIPTION OF THE DRAWINGS

The invention will be described by way of example and with reference to the accompanying drawings in which:

FIG. 1 is a front view of a non-pneumatic tire and rim assembly of the present invention;

FIG. 2 is a rear view of the non-pneumatic tire and rim assembly of FIG. 1;

FIG. 3 is an exploded view of the non-pneumatic tire and rim assembly of FIG. 1;

FIG. 4 is an exemplary vehicle with multiple non-pneumatic tire and rim assemblies of the present invention;

FIG. 5A is a front view of a spoke ring assembly, while FIG. 5B is a perspective view of the spoke ring assembly of FIG. 5A;

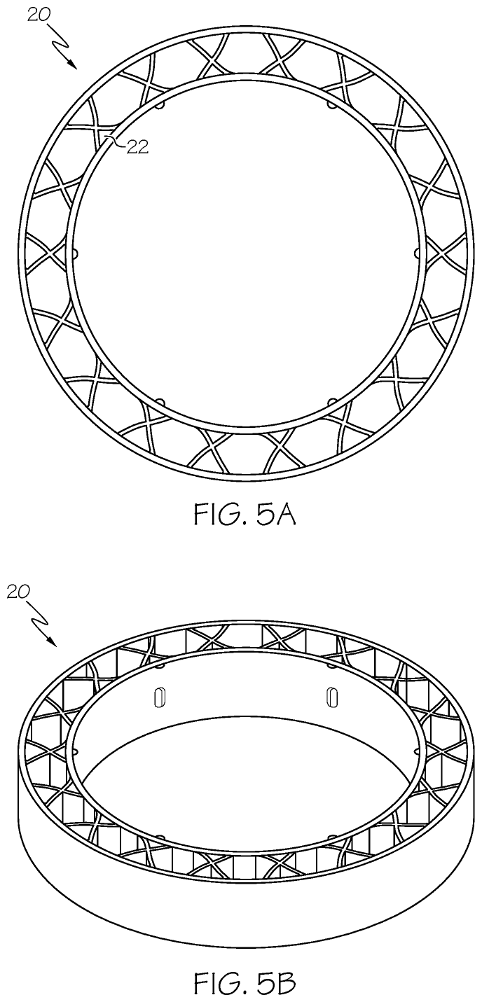

FIG. 6A is a perspective view of the left rim half, while FIG. 6B is a perspective view of the right rim half;

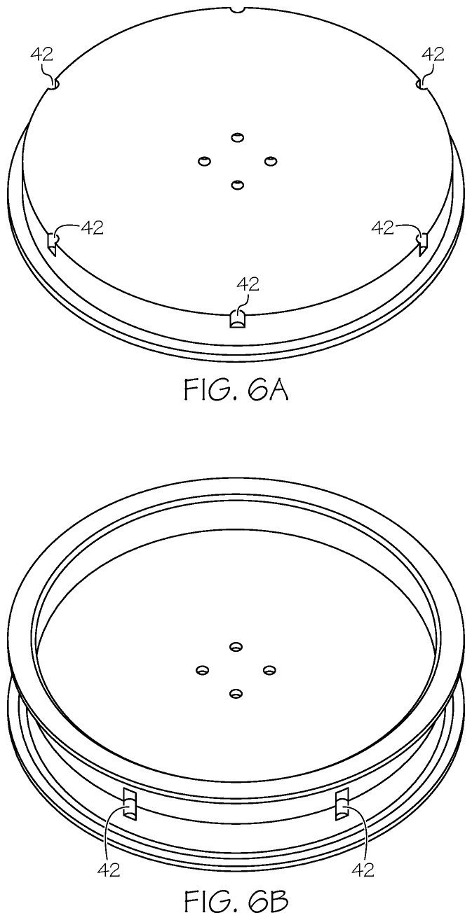

FIG. 7 is a close-up view cut away section of the non-pneumatic tire and rim assembly;

FIG. 8 is a perspective view of the split rim;

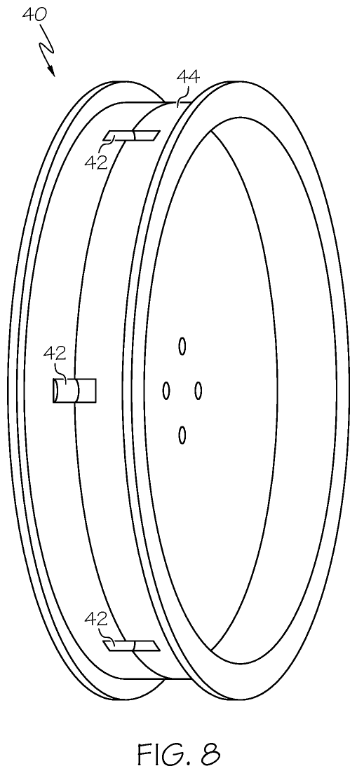

FIG. 9 is a close-up perspective view of the non-pneumatic tire and rim assembly; and

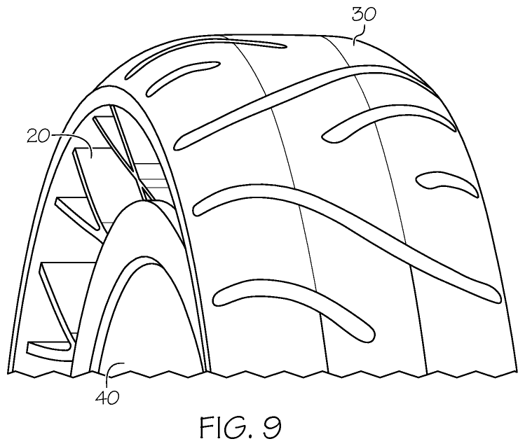

FIG. 10 is a close-up view of the retention nubs located on the inner ring of the spoke ring structure and the retention groove of the rim.

### DETAILED DESCRIPTION OF THE INVENTION

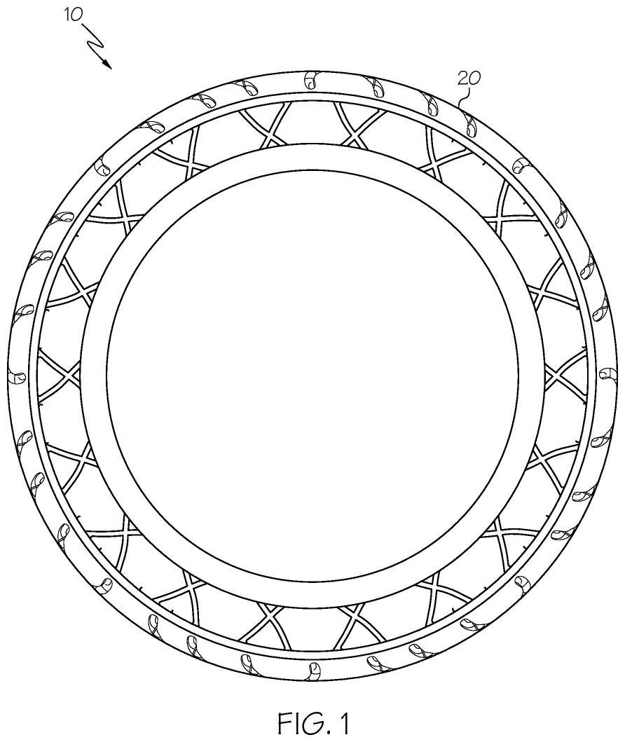

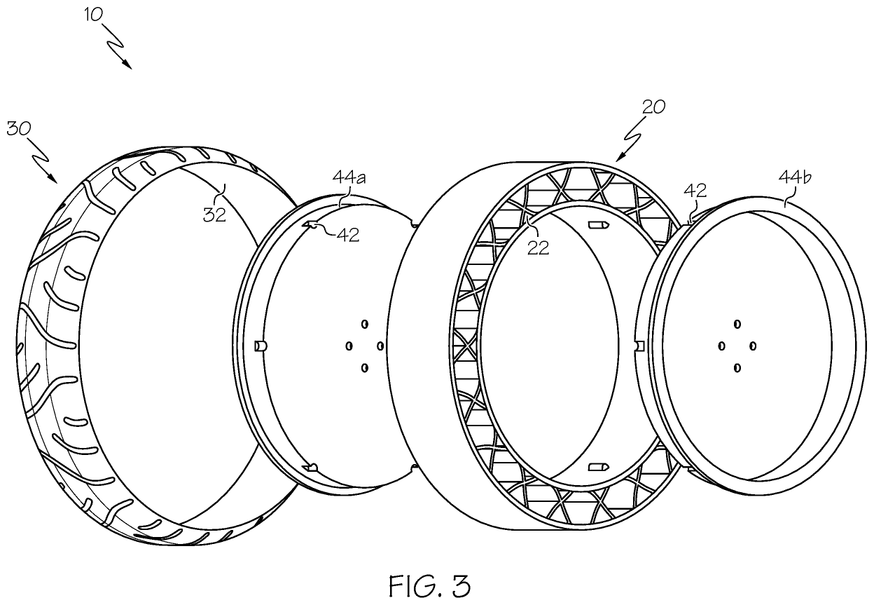

Referring to FIGS. 1, 2 and 3, a non-pneumatic tire and rim assembly 10 of the present invention is shown. The non-pneumatic tire and rim assembly 10 includes an outer annular tread ring 30, a spoke ring 20, and a rim 40. The outer annular tread ring 30 is preferably a one piece annular structure that is formed of a polymer, rubber or other desired elastomer. The tread ring 30 may be molded and cured as a one piece ring, and is mounted on the outer periphery of the spoke ring. The outer surface of the tread ring 30 may include tread elements such as ribs, blocks, lugs, grooves, and sipes as desired in order to improve the performance of the tire in various conditions.

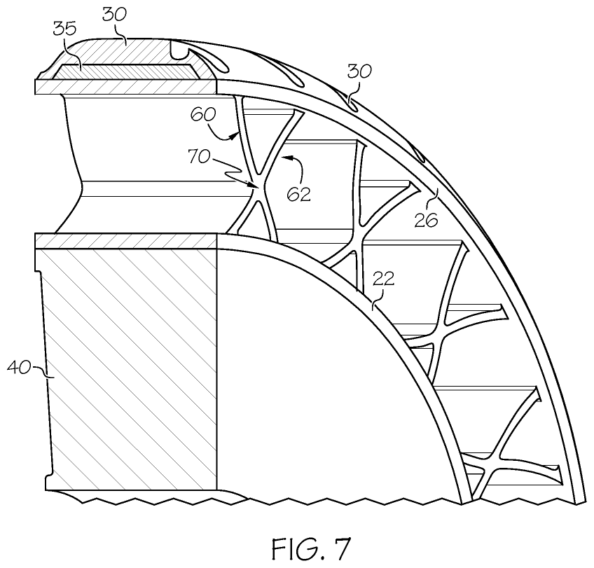

The tread ring 30 may include an optional shear ring 35, as shown in FIG. 7. The optional shear ring 35 is preferably a discrete ring, formed of a different material than the tread ring 30. Alternatively, the optional shear ring 35 may be integrally formed with the spoke ring 20, and located on the outer annular surface of the spoke ring. The optional shear ring 35 is preferably located between the outer circumference of the spoke ring, and the inner circumference of the tread ring. The optional shear ring 35 may optionally include one or more annular reinforcement layers, which could be fabric with optional parallel reinforcement cables preferably oriented in the zero degree (circumferential) orientation. The tread ring 30, optional shear ring 35 and spoke structure may be integrally formed via injection molding or three dimensional printing, or they may be formed in discrete components by injection molding or three dimensional printing and then assembled together.

### Spoke Ring Structure

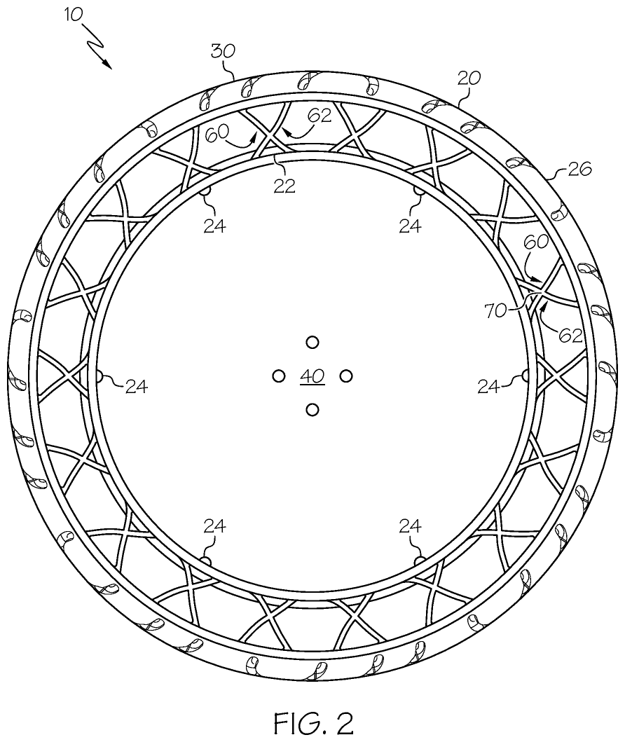

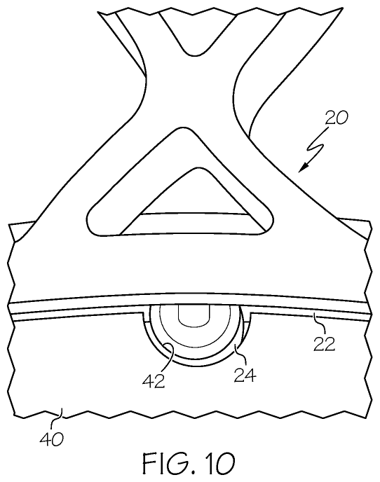

The non-pneumatic tire and rim assembly 10 further includes a spoke ring structure 20. The spoke ring structure 20 has an inner ring 22 that is mounted on the rim. The inner ring 22 has a plurality of retaining nubs or projections 24, as shown in FIG. 2 and FIG. 10. In this example, the nubs 24 are hemispherical or rounded in cross-sectional shape. However, the nubs 24 may be any desired shape. The retaining nubs 24 are received in complementary shaped grooves 42 located on the outer surface 44 of the rim 40.

The spoke ring structure further includes an outer ring 26 having an outer surface that is joined to the inner tread surface 32 by an adhesive polymer. The spoke ring structure further includes a plurality of spoke members that extend between the inner ring 22 to the outer ring 26. In a first example shown in FIGS. 2 and 7, the spoke ring structure has a first spoke member 60 that extends from the inner ring 22 to the outer ring 26 at an angle. The spoke ring structure includes a second spoke member 62 that also extends from the inner ring to the outer ring 26 at an angle. The first and second spoke member 60,62 are joined together at a junction 70 to form an X shaped spoke. The first and second spoke members 60,62 may be straight or curved.

The spoke ring structure 20 is preferably an integrally formed annular structure made of a resilient elastomeric material or moldable polymeric material such as natural rubber, styrene butadiene rubber, polybutadiene rubber or EPDM rubber or a blend of two or more of these rubbers which can be utilized in either injection molding or compression molding. The spoke ring structure 20 has an axial thickness equal to the axial thickness of the non-pneumatic tire. The spoke ring structure 20 has a plurality of spokes that connect an inner ring 22 and an outer ring 24.

The spoke disks are preferably formed of an elastic material, more preferably, a thermoplastic elastomer. The material of the spoke disks is selected based upon one or more of the following material properties. The tensile (Young's) modulus of the spoke disk material is preferably in the range of 15 MPa to 100 MPa, and more preferably in the range of 15 MPa to 100 MPa.

### Rim

The rim 40 is a split rim or two piece rim 44a,b that are joined together by fasteners to form a tire engaging surface 45 surrounded by tire-engaging flanges 46. The rim 40 is preferably of a substantially rigid material such as steel and has a tire-supporting outer circumferential surface.

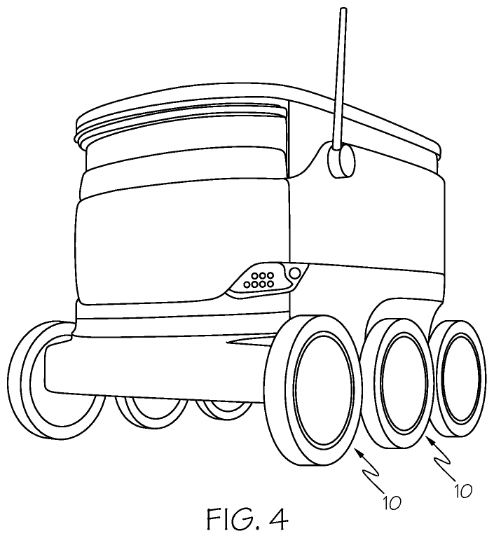

In one example, the tire of the present invention is provided on a mobile delivery vehicle 100 as shown in FIG. 4. The mobile delivery vehicle 100 has at least three, preferably four or more non-pneumatic tire and rim assemblies of the present invention, and more particularly, six non-pneumatic tire and rim assemblies. The tire has an outer rubber tread and a spoke ring structure that is injection molded and formed of a TPU or polyurethane material having a tensile modulus of about 10-100 MPA. The spoke ring structure may also be three dimensionally printed. The non-pneumatic tire and rim of the present invention has a spring rate in the range of 250 to 300 pounds per inch. The non-pneumatic tire and rim of the present invention has an axial width of about 1.5 inches with 15x to 24x shaped spokes having a radial height of about 1 inch. While the non-pneumatic tire and wheel assembly is described as having X shaped spokes, other spoke designs could be used. The rim has an outer diameter of about 5 inches, but could be sized to be smaller in the outer diameter to provide a greater radial height of the spoke ring structure.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A non-pneumatic tire and wheel assembly comprising: a rim, a spoke ring structure having an inner ring that is mounted on an outer surface of the rim, wherein the inner ring has one or more retention nubs aligned for reception in complementary shaped grooves on the outer surface of the rim, wherein the spoke ring structure has a plurality of spoke members, and an outer tread ring mounted on the outer circumference of the spoke ring.

2. The non-pneumatic tire and wheel assembly of claim 1 wherein the retention nubs are round in cross-section.

3. The non-pneumatic tire and wheel assembly of claim 1 wherein the spoke members of the spoke ring structure are joined together at a junction to form an X shaped spoke.

4. The non-pneumatic tire and wheel assembly of claim 1 wherein the rim is a two piece rim.

5. The non-pneumatic tire and wheel assembly of claim 1 further including a shear ring.

6. The non-pneumatic tire and wheel assembly of claim 5 wherein the shear ring is located between the tread ring and the spoke ring structure.

7. The non-pneumatic tire and wheel assembly of claim 5 wherein the shear ring is integrally formed with the spoke ring structure.

8. The non-pneumatic tire and wheel assembly of claim 1 wherein the non-pneumatic tire and wheel assembly is formed by three dimensional printing.

9. The non-pneumatic tire and wheel assembly of claim 1 wherein the spoke ring structure is formed of a polymer material having a tensile modulus in the range of 15 to 100 mpa.

10. A non-pneumatic tire and wheel assembly comprising: a rim, a spoke ring structure having an inner ring that is mounted on an outer surface of the rim, wherein the spoke ring structure has a plurality of spoke members, and aa shear ring mounted radially outward of the spoke ring structure, and wherein the shear ring is integrally formed with the spoke ring structure, and an outer tread ring mounted on the outer circumference of the spoke ring.

11. The non-pneumatic tire and wheel assembly of claim 10 wherein the inner ring has one or more retention nubs aligned for reception in complementary shaped grooves on the outer surface of the rim.
